(19) United States
(12) Patent Application Publication
(10) Pub. No.: US 2016/0052797 A1
(43) Pub. Date: Feb. 25, 2016

(54) METHODS AND SYSTEMS FOR USE IN TREATMENT OF LIQUIDS

(71) Applicant: Manuel J ECONOMEDES, Orefield, PA (US)

(72) Inventor: Manuel J ECONOMEDES, Orefield, PA (US)

(21) Appl. No.: 14/463,359

(22) Filed: Aug. 19, 2014

(51) Int. Cl. C02F 1/00

(52) U.S. Cl. CPC C02F 1/008; C02F 2101/12

(57) ABSTRACT

The present disclosure provides a method and system to monitor and/or determine a variety of parameters of a liquid stream in a system and to administer a treatment agent based on the determined parameters. Furthermore, the system and method of the present disclosure provide the ability to record and validate the determined parameters, as well the treatment methods employed and/or the operating parameters of the system.

### FIELD OF THE DISCLOSURE

The present disclosure relates generally to a system and method for water treatment. The present disclosure related more specifically to a system and method for water treatment to determine at least a first parameter of the water stream, optionally administering a treatment agent based on the determined parameter recording agents and the administration of the treatment agents in a secure fashion.

### BACKGROUND

Maintaining the sterility of various water systems is of paramount importance in a variety of settings. For example, in building water systems the presence of various pathogens has been documented to cause illness in individuals exposed to the pathogen present in the water system. In addition to the stress and inconvenience caused to the exposed individual and the monetary costs associated with treatment of the illness, the owners and operators of the water system and the premises can be liable to the individual for damages related to the illness.

While a number of systems to monitor for the presence of pathogens in a water supply and administering treatments to the water supply in response to such are known, the methods and devices of the prior art do not allow for the ability of an owner or operator of a water system to validate the safety of the water system or that the operation of the water system is conducted in accordance with industry and governmental standards and best practices. Furthermore, the methods and devices of the prior art do not allow the levels of pathogens that may be present in the water system to be validated or to validate the treatment strategies employed. As a result, the owners and operators of the water system are at a disadvantage in proving the safe operation of the water system. As a result, the owners and operators of the water system may face liability for a perceived defect in the water system, even when the water system was operated in compliance with industry and governmental standards and practices.

Despite the need for a water treatment system that can validate the safety of the water system, that the operation of the water system is conducted in accordance with industry practices, the levels of pathogens that may be present in the water system, the treatment strategies employed and other such factors, the prior art has not provided for such a device. The present disclosure provides a novel method and system to monitor and/or determine a variety of parameters of a liquid stream in a system and to administer a treatment agent based on the determined parameters. Furthermore, the system and method of the present disclosure provide the ability to record and validate the determined parameters, as well the treatment methods employed and/or the operating parameters of the system. Such a system and method were not previously appreciated in the art.

### BRIEF DESCRIPTION OF THE FIGURES

FIG. 1 shows a diagram of one embodiment of the bypass loop.

FIG. 2 shows a diagram of one embodiment of the drain lines

FIG. 3A shows the operation of one embodiment of the halogen monitoring and control system.

FIG. 3B shows the operation of an alternate embodiment of the halogen monitoring and control system.

FIG. 4 shows the operation of one embodiment of the biofilm monitoring and control system.

FIG. 5 shows the operation of one embodiment of the routine cleaning and disinfection system.

### DETAILED DESCRIPTION

The present disclosure provides a novel system and method to monitor and/or determine a variety of parameters of a liquid stream in a system and to administer a treatment agent based on one or more of the determined parameters. Furthermore, the system and method of the present disclosure provide the ability to record and validate the determined parameters, as well the treatment methods employed and/or the operating parameters of the system at any given time.

The system described is used in conjunction with a water system. In the particular embodiment described herein, the water system is part of a cooling tower that is commonly found in commercial buildings. However, the system and method described may be used in conjunction with other water systems and other configurations as is known in the art. Furthermore, the system and method described may be used in conjunction with any liquid stream and is not limited to water systems.

In a general embodiment, the system comprises at least one test point, at least one treatment point, a control unit and a legal storage unit. The system may further comprise a bypass loop and one or more drainage conduits. In one embodiment, the system further comprises a bypass loop and the test points and treatment points are located in the bypass loop. The system may further comprise ancillary conduits for interconnecting the various described components, validating means (such as flow sensors or flow meters), injection elements (such as pumps) and other items normally found in such water systems.

The system of the present disclosure may take on a variety of configurations.

In a first embodiment, the present disclosure provides a system for water treatment, wherein the system comprises at least one test point in communication with a water stream for determining a parameter of the water stream, at least one treatment point in communication with the water stream to release a treatment agent into the water stream, a control unit which receives information regarding the parameter and directs the initiation of a treatment action if the parameter determined triggers a treatment decision and a legal storage unit, where the control unit and/or the legal storage unit each records at least one piece of information regarding the water system.

In a second embodiment, the present disclosure provides a system for water treatment, wherein the system comprises at least two test points in communication with a water stream for determining a first and second parameter of the water stream, at least one treatment point in communication with the water stream to release a treatment agent into the water stream, a control unit which receives information regarding the first and second parameters and directs the initiation of a treatment action if one or both of the first and/or second parameters triggers a treatment decision and a legal storage unit, where the control unit and/or the legal storage unit records at least one piece of information regarding the water system.

In a third embodiment, the present disclosure provides a system for water treatment, wherein the system comprises at least three test points in communication with a water stream for determining a first, second and third parameters of the water stream, at least one treatment point in communication with the water stream to release a treatment agent into the water stream, a control unit which receives information regarding the first, second and third parameters and directs the initiation of a treatment action if one or more of the first, second and/or third parameters trigger a treatment decision and a legal storage unit, where the control unit and/or the legal storage unit records at least one piece of information regarding the water system.

In a fourth embodiment, the present disclosure provides a system for water treatment, wherein the system comprises at least three test points in communication with a water stream for determining the level of a first, second and third parameter of the water stream, at least two treatment point in communication with the water stream to release a treatment agent into the water stream, a control unit which receives information regarding the first, second and third parameters and directs the initiation of a treatment action if one or more of the first, second and/or third parameters trigger a treatment action and a legal storage unit, where the control unit and/or the legal storage unit records at least one piece of information regarding the water system.

In the foregoing embodiments, the parameter tested may be any parameter of the water system known in the art. Parameters that may be tested include, but are not limited to, the level of a particular compound or substance, the level of a biocide, the presence and/or level of biofilm, the presence and/or level of an agent indicative of the presence of biofilm, the presence and/or level of a bacteria, the presence and/or level of an agent indicative of the presence of a bacteria or a combination of the foregoing. As described herein, multiple parameters may be tested together. Furthermore, the parameters may be determined on an essentially constant basis or at a pre-determined interval. The pre-determined interval (also referred to as a defined schedule) is independently selected from every 5 second, every 30 seconds, every 45 seconds, every minute, every 5 minutes, every 30 minutes, every hour, every 5 hours, every 12 hours or every 24 hours; other time points may also be used.

In the foregoing embodiments, the at least one piece of information regarding the water system may be the value of the parameter tested, whether the value triggered a treatment action, the treatment action taken, information regarding the treatment action, such as, but not limited to, the amount of treatment agent released, the time of the release of the treatment agent and the duration of the treatment, and the operating conditions of the water system at any point in time. Information may be recorded regardless of whether a treatment action is taken. Other information may be recorded as is known in the art.

In the foregoing embodiments, the treatment action may be any action required to be taken based on the parameter measured. The treatment action taken may vary depending on the parameter tested and the determined level of the parameter tested. Exemplary treatment actions include, but are not limited to, the release of an amount of the treatment agent from the treatment point into the water stream, the drainage of water from the system, the addition of water from the system or a combination of the foregoing. The treatment action taken may also vary with the value of a single given parameter. For example, if the parameter is the value of the biocide parameter, the treatment action may be an addition of biocide if the value of the biocide parameter is to low or the drainage of a portion of the water from the water system if the value of the biocide parameter is too high.

As used herein the term “triggers a treatment decision” means that the value determined for a particular parameter is within a range that has been determined to require a treatment action to be taken to return the water system to normal or preferred operating conditions. The range is determined with respect to each parameter tested; as such the range may vary depending on each parameter. Each parameter may have a single range or more than one range that has been determined to require a treatment action to be taken. The value determined for each parameter may be the level of the parameter, the concentration of the parameter, a numerical value indicative of the level or concentration of the parameter, the presence of the parameter at any concentration of level or other representations as known in the art.

Exemplary ranges for each parameter can vary depending on the type of water system, the use of the water system and the operating parameters of the water system. Exemplary ranges for parameters that may be tested are shown in Table 1 below. The ranges below are exemplary only and should not be construed to limit the ranges useful with the present disclosure to those ranges disclosed below. Furthermore, the ranges for a particular parameter may vary depending on the nature of the parameter. For example, representative biocides include, but are not limited to, halogens such as, but not limited to, bromine and chlorine as well as chlorine dioxide. The ranges for each bromine, chlorine and chlorine dioxide may vary as is known in the art.

| Parameter | Range | Treatment Action |
|---|---|---|
| Conductivity | Dependent on | Drain water from water |
| | Water Quality | system |
| Biocide (Chlorine) | Less than | Add biocide (for example, free |
| | | chlorine or a chlorine donor) |
| Biocide (chlorine) | Greater than | remove water from the |
| | | system |
| Biofilm | Presence of | Add biodispersant and add |
| | biofilm | biocide |
| Agent indicative of the | Greater than | Add biodispersant and add |
| presence of biofilm (for | | biocide |
| example, adenosine tri- | | |
| phosphate) | | |

For example, if the parameter is the value, for example the concentration, of a biocide (such as but not limited to free halogen) the value of the biocide parameter may trigger a treatment decision if the value of the biocide parameter is too low and as a result the biocide is not properly inhibiting the growth of biological organisms. In this case, the treatment action is the release of biocide (such as, but not limited to, free halogen or a free halogen donor) into the water stream to increase the value of the biocide parameter to a normal or preferred level. Furthermore, if the parameter is the concentration of a biocide (such as but not limited to free halogen) the value of the biocide parameter may trigger a treatment decision if the concentration of the biocide is to high and as a result the biocide may be promoting corrosion of the system or be at a level that cannot be released into a natural body of water. In this case, the treatment action is the drainage of water from the system to restore the levels of biocide to a normal or preferred level.

In another example, if the parameter is the presence of biofilm, the value of the biofilm parameter may trigger a treatment decision if the value of the biofilm parameter is too high (such as the detection of any amount of biofilm) indicating that the water system may be contaminated. In this case, the treatment action is the release of a biodispersant followed by the release of a biocide (such as, but not limited to, free halogen or a free halogen donor) into the water stream and optional drainage of water from the system to return the value of the biofilm parameter to a normal or preferred level.

In another example, if the parameter is the value of conductivity, the value of the conductivity parameter may trigger a treatment decision if the value of the conductivity parameter is too high indicating that the water system may be at risk for scaling and the like. In this case, the treatment action is the drainage of water from the system to return the value of the conductivity parameter to a normal or preferred level.

In the foregoing embodiments, the control unit receives information regarding the operation of the system in addition to a parameter of the water stream and the control unit records at least a portion of the information regarding the operation of the system in addition to at least one parameter of the water stream.

In the foregoing embodiments, the control unit and the legal storage unit receives information regarding the operation of the system in addition to a parameter of the water stream and the control unit and the legal storage unit records at least a portion of the information regarding the operation of the system in addition to at least one parameter of the water stream.

In one particular embodiment, the water system comprises a first test point for determining the value of the biocide parameter, a second test point for determining the value of the biofilm parameter, a single treatment point, a control unit which receives information regarding the stated parameters and directs the initiation of a treatment action if the value of the stated parameter determined triggers a treatment decision and a legal storage unit, where the control unit and/or the legal storage unit each records at least one piece of information regarding the water system. When the value of the biocide parameter triggers a treatment action requiring the addition of a biocide treatment agent (for example, if the value of the biocide parameter is too low), the treatment point releases the biocide treatment agent into the water stream. When the value of the biocide parameter triggers a treatment (for example, if the value of the biocide parameter is too high), the water system takes a specified action (for example, discharge/drainage of a portion of the water from the water system). When the value of the biofilm parameter triggers a treatment action requiring the addition of a biofilm treatment agent, the treatment point releases a biofilm treatment agent into the water stream; such action may be followed by the release of a biocide treatment agent into the water stream and/or the implementation of a specific action by the water system (for example, discharge/drainage of a portion of the water from the water system). In a particular embodiment, the biocide parameter is free halogen, the biofilm parameter is the presence of biofilm or an agent indicative of the presence of biofilm, the biocide treatment agent is free halogen or a free halogen donor, the biofilm treatment agent is a biodispersant and the specified action is a discharge/drainage (or blow down) of a portion of the water in the water system.

In another particular embodiment, the water treatment system comprises a first test point for determining the value of the biocide parameter, a second test point for determining the value of the biofilm parameter, a first treatment point for releasing a biocide treatment agent, a second treatment point for releasing a biofilm treatment agent, a control unit which receives information regarding the stated parameters and directs the initiation of a treatment action if the value of the stated parameter determined triggers a treatment decision and a legal storage unit, where the control unit and/or the legal storage unit each records at least one piece of information regarding the water system. When the value of the biocide parameter triggers a treatment action requiring the addition of a biocide treatment agent (for example, if the value of the biocide parameter is too low), the treatment point releases the biocide treatment agent into the water stream. When the value of the biocide parameter triggers a treatment action (for example, if the value of the biocide parameter is too high), the water system takes a specified action (for example, discharge/drainage of a portion of the water from the water system). When the value of the biofilm parameter triggers a treatment action requiring the addition of a biofilm treatment agent, the treatment point releases a biofilm treatment agent into the water stream; such action may be followed by the release of a biocide treatment agent into the water stream and/or the implementation of a specifified action by the water system (for example, discharge/drainage of a portion of the water from the water system). In a particular embodiment, the biocide parameter is free halogen, the biofilm parameter is the presence of biofilm or an agent indicative of the presence of biofilm, the biocide treatment agent is free halogen or a free halogen donor, the biofilm treatment agent is a biodispersant and the specified action is a discharge/drainage (or blow down) of a portion of the water in the water system.

In yet another particular embodiment, the water treatment system comprises a first test point for determining the value of the biocide parameter, a second test point for determining the value of the biofilm parameter, a third test point for determining the value of the conductivity parameter, a single treatment point, a control unit which receives information regarding the stated parameters and directs the initiation of a treatment action if the value of the stated parameter determined triggers a treatment decision and a legal storage unit, where the control unit and/or the legal storage unit each records at least one piece of information regarding the water system. When the value of the biocide parameter triggers a treatment action requiring the addition of a biocide treatment agent (for example, if the value of the biocide parameter is too low), the treatment point releases the biocide treatment agent into the water stream. When the value of the biocide parameter triggers a treatment action (for example, if the value of the biocide parameter is too high), the water system takes a specified action (for example, discharge/drainage of a portion of the water from the water system). When the value of the biofilm parameter triggers a treatment action requiring the addition of a biofilm treatment agent, the treatment point releases a biofilm treatment agent into the water stream; such action may be followed by the release of a biocide treatment agent into the water stream and/or the implementation of a specified action by the water system (for example, discharge/drainage of a portion of the water from the water system. When the value of the conductivity parameter triggers a treatment action (for example, if the value of the conductivity parameter is too high), the water system takes a specified action (for example, discharge/drainage of a portion of the water from the water system). In a particular embodiment, the biocide parameter is free halogen, the biofilm parameter is the presence of biofilm or an agent indicative of the presence of biofilm, the biocide treatment agent is free halogen or a free halogen donor, the biofilm treatment agent is a biodispersant and the specified action is a discharge/drainage (or blow down) of a portion of the water in the water system.

In still another particular embodiment, the water treatment system comprises a first test point for determining the value of the biocide parameter, a second test point for determining the value of the biofilm parameter, a third test point for determining the value of the conductivity parameter, a first treatment point for releasing a biocide treatment agent, a second treatment point for releasing a biofilm treatment agent, a control unit which receives information regarding the stated parameters and directs the initiation of a treatment action if the value of the stated parameter determined triggers a treatment decision and a legal storage unit, where the control unit and/or the legal storage unit each records at least one piece of information regarding the water system. When the value of the biocide parameter triggers a treatment action requiring the addition of a biocide treatment agent (for example, if the value of the biocide parameter is too low), the treatment point releases the biocide treatment agent into the water stream. When the value of the biocide parameter triggers a treatment action (for example, if the value of the biocide parameter is too high), the water system takes a specified action (for example, discharge/drainage of a portion of the water from the water system). When the value of the biofilm parameter triggers a treatment action requiring the addition of a biofilm treatment agent, the treatment point releases a biofilm treatment agent into the water stream; such action may be followed by the release of a biocide treatment agent into the water stream and/or the implementation of a specified action by the water system (for example, discharge/drainage of a portion of the water from the water system). When the value of the conductivity parameter triggers a treatment action (for example, if the value of the conductivity parameter is too high), the water system takes a specified action (for example, discharge/drainage of a portion of the water from the water system). In a particular embodiment, the biocide parameter is free halogen, the biofilm parameter is the presence of biofilm or an agent indicative of the presence of biofilm, the biocide treatment agent is free halogen or a free halogen donor, the biofilm treatment agent is a biodispersant and the specified action is a discharge/drainage (or blow down) of a portion of the water in the water system.

### Control Unit

In one embodiment of the foregoing aspects, the control unit controls and/or monitors at least a portion of the operating functionalities of the water system. The control unit may also record such information. Such information includes the value of the measured parameters (such as biocide levels, biofilm levels and conductivity), when a measured parameter triggers a treatment action, when a treatment agent is released, the volume of the treatment agent released, the times of treatment agent addition, the time when the treatment agent addition terminates, specified action taken by the water system, information related to the routine maintenance of the system, when the level of a treatment agent is low, the operating parameters of the water system, a change to an operating parameter of the system is changed, and information related to blow down or drainage of water from the system (such as the length of time of the blow down, the start and stop times of the blow down, the amount of water drained from the system, the amount of make up water added and the like). The control unit may be a single unit or may comprise one or more units that operate together in the above-recited fashion. Furthermore, the control unit may be in communication with other components of the water system to control, at least partially, such components. The control unit, or portions thereof, may be placed within the water system itself or may be located remotely from the water system.

The control unit is also capable of displaying information, such as the parameters determined by the test points or information regarding the operation of the system to a user. Such display may be through a monitor or other visual means. Furthermore, the control unit may monitor the system and send alerts to a user on the occurrence of a particular condition of the system or on the occurrence of a particular event. For example, the control unit may send an alert to a user when a measured parameter triggers a treatment action, when a treatment agent is released, when a specified action is taken, when the level of a treatment agent is low or when an operating parameter of the system is changed. Furthermore, the control unit may send an alert to a user when a parameter of the water system, such as for example, biofilm, conductivity or biocide levels is changed. Such alert may be in the form of a visual display, a text message, an e-mail, an audible alert of the like. Combinations of the foregoing may also be used.

### Legal Storage Unit

In one embodiment legal storage unit records information relating to the system. The legal storage unit may be a single unit or may comprise one or more units that operate together in the above-recited fashion. In one embodiment, the legal storage unit is a single unit. Furthermore, the legal storage unit may be in communication with other components of the water system such as the control unit, the treatment points or components thereof and the test points or components thereof. The legal storage unit, or portions thereof, may be placed within the water system itself or may be located remotely from the water system. In one embodiment, the legal storage unit is located remotely from the water system.

The function of the legal storage unit is to record information relating to the water system in a secure manner to provide validation of the operating parameters of the water system. A variety of information may be recorded on the legal storage unit. Such information includes the value of the measured parameters (such as biocide levels, biofilm levels and conductivity), when a measured parameter triggers a treatment action, when a treatment agent is released, the volume of the treatment agent released, the times of treatment agent addition, the time when the treatment agent addition terminates, when a specified action is taken, information related to the routine maintenance of the system, when the level of a treatment agent is low, the operating parameters of the water system, a change to an operating parameter of the system is changed, and information related to blow down or drainage of water from the system (such as the length of time of the blow down, the start and stop times of the blow down, the amount of water drained from the system, the amount of make up water added and the like). Other information may also be recorded. Through the information in the legal storage unit, it is possible to verify that the water system is operating according to best practices and that the levels of contaminants in the water system are absent or within an acceptable range. As a result, the manufacturer and/or operator of the water system may prove that the water system is functioning properly.

In one embodiment, only a defined group has access to the information recorded on the legal storage unit. In another embodiment, a first defined group has access to information recorded on the control unit and a second defined group has access to the information recorded on the legal storage unit.

In one embodiment, the information recorded on the legal storage unit cannot be altered. In a further embodiment, if any attempt is made to alter the information recorded on the legal storage unit or any attempt is made to access the information recorded on the legal storage unit from a group that is not authorized to access such information, the attempt is recorded and an alert is sent to notify a user or a defined group. The alert function is discussed herein and any form of such an alert, or any combination thereof, may be utilized. In such an embodiment, the legal storage unit may comprise an anti-tampering device.

In one embodiment, the legal storage unit provides legally sufficient evidence of the information recorded on the legal storage unit.

### Test and Treatment Points

In one embodiment, each test point comprising a sensor capable of measuring a given parameter. A variety of parameters may be monitored, including biofilm, an agent indicative of the presence of biofilm, biocide levels, conductivity, temperature and pH. Other parameters may be monitored as well. The nature of the sensor will vary depending on the parameter detected. A variety of sensors for the detection of the recited parameters are commercially available and any such sensor may be used in connection with the present disclosure.

In a particular embodiment, the measured parameters are a biofilm parameter, a biocide parameter and a conductivity parameter. In one embodiment, the biocide is halogen. Sensors capable of measuring biofilm are available from Structural Integrity Associates (BioGeorge BG3) and Process Instruments (CRONOS Biosense). Sensors capable of measuring biocides are available from Hach (C117), HF Scientific (CLX) and Chemtrol (PC7000). Sensors capable of measuring conductivity are available from Advantage (Megatron), Chemtrol (CT3000) and Walchem (Webmaster). The list of manufacturers and sensors is illustrative only and is not to limit the disclosure to the examples listed above.

In one embodiment, each treatment point comprises a pump, to control the release of the treatment agent and a reservoir of the treatment agent. Each treatment point may further comprise at least one of the following; (i) a validating element, such as, but not limited to, a sensor of flow meter, to measure the amount of treatment agent released; and (ii) an injection element, such as, but not limited to, a pump, to force the treatment agent into the water stream.

The nature of the treatment agent depends on the parameter for which the treatment agent is released. As discussed above, two specific parameters that are measured by the system of the present disclosure are biocide levels and biofilm levels. A biocide treatment agent released in response to the biocide parameter includes bromine, chlorine, ozone, and chlorine dioxide. A biofilm treatment agent released in response to the biofilm parameter includes, but is not limited to, oxidizing biocides, such as, but not limited to, bromine, chlorine, ozone, and chlorine dioxide, as well as polymers and other biofilm treatment agents, such as, but not limited to, glycol, amine and glycoside based products. In certain embodiments, a combination of an oxidizing biocide and another biofilm treatment agent. In certain embodiments, a single compound may be both a biocide and a biofilm treatment agent; for example, oxidizing biocides, such as, but not limited to, bromine, chlorine, ozone, and chlorine dioxide.

### General Operation

The following describes one embodiment of the system and method of the present disclosure. This exemplary disclosure is not meant to be limiting. One of ordinary skill in the art will realize modifications to the disclosed system and method and such modifications are intended to be included herein as supported by the remainder of the specification and the knowledge in the art.

The water system in general may be any water system known in the art. In the particular embodiment described herein, the water system is part of a cooling tower that is commonly found in commercial buildings. However, the system and method described may be used in other water systems and other configurations as is known in the art.

In this embodiment, the water system comprises a main water circulation system as is known in the art and a bypass loop. The bypass loop allows water from the main water system to flow to and from the test points and the treatment points. In one embodiment, the test points and treatment points are located in the bypass loop. While a bypass loop is an efficient means for accomplishing the foregoing, the treatment points and test points may be located with the main water system if desired. A combination of the foregoing may also be used.

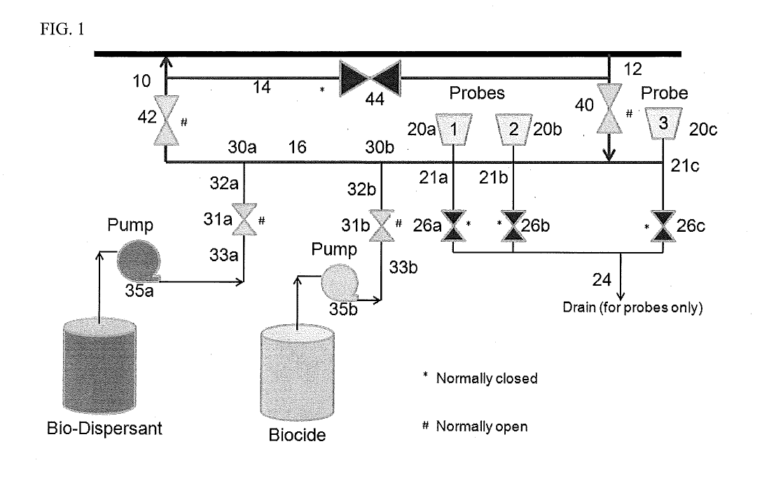

A representative configuration of the bypass loop is shown in FIG. 1. In this embodiment, the bypass loop is in communication with a portion of the main water system (designated 1) through two (2) conduits 10 and 12. As used herein, the term conduits is meant to be interpreted broadly and refers to any device capable of transporting water through the system, such as but not limited to a pipe. The material comprising the conduits is not critical to the present disclosure. Conduits 10 and 12 each comprise a valve, designated 40 and 42, for regulating flow of the water into the bypass loop. Conduit 16 completes the bypass loop and is in communication with conduits 10 and 12 through valves 40 and 42, respectively. Conduits 10 and 12 are connected by conduit 14. Conduit 14 further comprises a valve 44. In operation, valves 40 and 42 are normally open and valve 44 is normally closed, thereby allowing water to flow through conduits 10, 12 and 16 allowing the water to be in communication with the test points and treatment points (described below). When it is desired to isolate the bypass loop from the main water system (such as may be required for maintenance and the like), valves 40 and 42 may be closed and valve 44 opened, allowing the water through conduits 10, 14 and 12 and back to the main water system 1.

In the embodiment shown in FIG. 1, the bypass loop comprises three test points, designated 20a, 20b and 20c, positioned along conduit 16. The location of the test points is illustrative only and the test points may be positioned in other configurations as is known in the art. As discussed above, the test points may be located in the main water circulation system. In one embodiment, the test points are separated by sufficient distance to allow for proper readings. In a particular embodiment, the distance of separation is at least 6-12 inches. Each test point is in communication with the water flowing through conduit 16 and comprises a sensor, designated 21a, 21b and 21c, for determining a parameter of the water stream. The nature of the sensors is discussed herein. In this embodiment, the sensors detect the parameters (i) biocide, such as but not limited to, halogen; (ii) biofilm or an agent indicative of the presence of biofilm; and (iii) conductivity of the water stream. Such sensors are available from commercial sources. Furthermore, conduit 16 may comprise a drain conduit 24 which is in communication with a drain valves 26a, 26b and 26c (one for each test point in this example) allowing the water in conduit 16 to be drained. In one embodiment, water from the conduit 16 is in communication with the test points 20a-c in a continuous manner. As discussed herein, the test points, or components thereof, may be in communication with other components of the system, such as, but not limited to, the control unit and the legal storage unit. In one embodiment, the details regarding the testing of the parameter are recorded by a component of the system, such as the control unit and/or the legal storage unit. Relevant details include, but are not limited to, the parameter tested, the value of the parameter that was determined, whether the value determined for the parameter triggered a treatment action and the like. Additional information that may be recorded is discussed herein.

In the embodiment shown in FIG. 1, the bypass loop further comprises two (2) treatment points, designated 30a and 30b, positioned along conduit 16 for the release of a treatment agent into the water stream. The location of the treatment points is illustrative only and the treatment points may be positioned in other configurations as is known in the art. As discussed above, the treatment points may be located in the main water circulation system. In one embodiment, the treatment points are separated by sufficient distance to allow for proper feeding of the treatment agent into the water stream. In a particular embodiment, the distance of separation is at least 6-12 inches. Each treatment point comprises a valve, a reservoir of the treatment agent and an injection element to force the treatment agent into the water stream. Each treatment point may further comprise a validating element, such as, but not limited to, a sensor of flow meter, to measure the amount of treatment agent released. As shown in FIG. 1, the treatment points 30a and 30b are joined to conduit 16 of the bypass loop by conduits 32a and 32b, respectively. Valves 31a and 31b are positioned between conduits 32a and 32b and conduits 33a and 33b. Conduits 33a and 33b are in communication with reservoirs 34a and 34b containing treatment agent. An injection element, such as but not limited to a pump, designated 35a and 35b may be associated with each reservoir to urge the treatment agent from the reservoir. In addition, a validating element, designated 36a and 36b may be associated with each treatment point to monitor and/or control the amount of treatment agent fed into the water stream. Alternatively, the injection element may be calibrated to deliver a known amount of treatment agent per unit time and the validating means may not be required to determine the amount of treatment agent released; in such an embodiment, the validating element may still be present to monitor the amount of treatment agent fed into the water stream. In one embodiment, conduits of the treatment points will be sized sufficiently (minimum ¾″) to avoid clogging. The nature of the treatment agents released by the treatment points is discussed herein. In one embodiment, the treatment agent is: (i) free halogen or a free halogen donor; and (ii) a biodispersant. As discussed herein, the treatment points, or components thereof, may be in communication with other components of the system, such as, but not limited to, the control unit and the legal storage unit. The inventory of treatment agent may be monitored at a pre-set frequency by the controller or another component of the system. The treatment agent inventory is recorded by the control unit and/or the legal storage unit. If inventory is found to be inadequate for either routine or reactionary purposes and alert is sent to notify a user or a defined group of the inventory levels and to signal the need for replenishment of the treatment agent. The alert function is discussed herein and any form of such an alert, or any combination thereof, may be utilized. In one embodiment, the details regarding the administration of the treatment agent are recorded by a component of the system, such as the control unit and/or the legal storage unit. Relevant details include, but are not limited to, the type of treatment agent administered, the inventory of the treatment agent, the parameter that triggered the release of the treatment agent, the amount of treatment agent released, the duration of the application of the treatment agent, the start and stop time of the treatment agent addition and the like.

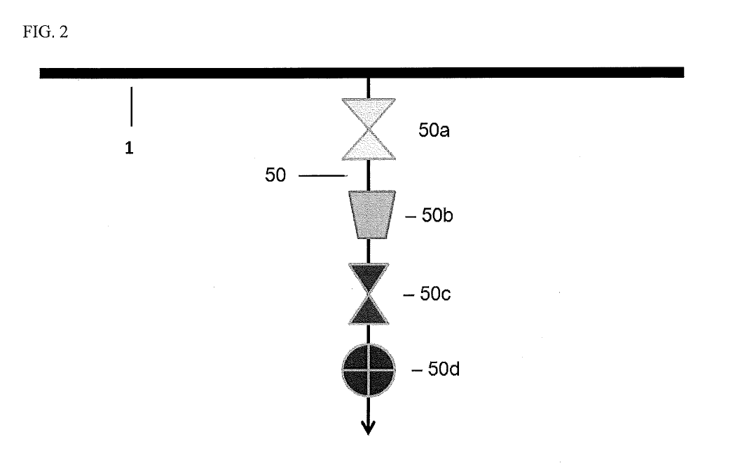

In one embodiment, the water system is also equipped with one or more drain conduits to allow for blow down (drainage) of the water system. Such blow down conduits are commonly used in water systems. An exemplary embodiment is shown in FIG. 2. In this embodiment, one drain conduits is shown, however, multiple drain conduits may be used if desired. FIG. 2 illustrates one conduit designated 50 in communication with conduit 1 of the main water circulation system. Conduit 50 is separate from the bypass loop illustrated in FIG. 1, such conduit may be used for routine blow down for controlling cycles of concentration, for continuous blow down after detecting a high level of a parameter (for example biofilm) or for routine cleaning and disinfection. Conduit 50 is sized sufficiently (minimum ¾″) to avoid clogging. The composition of the conduit 50 is as known in the art. In one embodiment, conduit 50 comprises a first valve designated 50a, a filter designated 50b, a second valve designated 50c and a meter designated 50d. In one embodiment, the first valve is a manual valve, such as a throttling valve to throttle the water flow, and is typically at least partially open. In one embodiment, the second valve is a solenoid type valve and is under the control of the control unit or other component of the system. The filter ensures that particles or contaminants in the water stream do not clog the second valve. While the filter is shown in FIG. 2 between the first and second valves, the filter may be placed in front of the first valve if desired. The meter measures the water drained from the system. As discussed herein, the drain conduit, or components thereof, may be in communication with other components of the system, such as, but not limited to, the control unit and the legal storage unit. In one embodiment, the details regarding the blow down are recorded by a component of the system, such as the control unit and/or the legal storage unit. Relevant details include, but are not limited to, the amount of water drained from the system, the duration of the blow down, the start and stop times of the blow down procedure and the like.

During operation of the water system, the treatment points check the respective parameters of the water stream, such as, but not limited to, conductivity, biocide levels and bio-film levels and transmit the information to a component of the system, such as the controller and/or the legal storage unit where such information is recorded. The test points may be programmed to check the various parameters or may be directed to check the various parameters by a component of the system, such as the control unit. The test points may take readings of the parameters on an essentially constant basis or at a pre-determined interval or schedule. The pre-determined interval may be set by a user or a defined group. The pre-determined intervals may be input into the control unit or may be input into each test point individually. The pre-determined interval may be the same or may be different for each parameter. In one embodiment, the pre-determined interval for each parameter can be changed only by a defined group of individuals. Further, in one embodiment, any change in the pre-determined interval for a parameter or any attempt to change the pre-determined interval for a parameter is recorded by a component of the system, such as the controller of the legal storage unit. In one embodiment, the pre-determined interval (also referred to as a defined schedule) is independently selected from every 5 second, every 30 seconds, every 45 seconds, every minute, every 5 minutes, every 30 minutes, every hour, every 5 hours, every 12 hours or every 24 hours; other time points may also be used.

If the parameter does not trigger a treatment action (for example, it is within an acceptable range), then no action is taken and the parameter is recorded by a component of the system, such as the controller and/or the legal storage unit. Values for each parameter that trigger a treatment action may be input into the control unit. In one embodiment, such values can be changed only by a defined group of individuals. Further, in one embodiment, any change such values or any attempt to change such values is recorded by a component of the system, such as the controller of the legal storage unit. If the parameter triggers a treatment action (for example, it is outside of an acceptable range), then an action is taken based on the individual parameter; furthermore, the parameter is recorded by a component of the system, such as the controller and/or the legal storage unit. The action implemented will vary based on the given parameter and the level of the parameter.

### Conductivity Monitoring and Control

If the parameter is conductivity (or cycles of concentration), a test point will determine the conductivity parameter. The results (the value of the parameter) are recorded by a component of the system, such as the controller and/or the legal storage unit.

If the conductivity parameter determined by the test point triggers a treatment action, the controller will direct the system to take a specified action. The specified action taken may depend on factors known in the art, such as the composition of the water/make-up water utilized by the system and the operating parameters of the system. Therefore, the specific actions taken regarding the conductivity parameter may vary depending on the forgoing. If the value for the conductivity parameter is too high, the controller activates a blow down (or drainage) of a portion of the water in the system. In one embodiment, such activation is through the drain conduit 50. The controller may also send an alert to notify a user or a defined group of the action or level of the conductivity parameter. The alert function is discussed herein and any form of such an alert, or any combination thereof, may be utilized. In such an operation, the first valve is open (at least partially) and the second valve is opened by the controller and an amount of water is drained from the system. In one embodiment the amount of water drained from the system is based on the conductivity value determined by the test point, a set time period or a combination of the foregoing. In one embodiment, the controller determines the appropriate amount of water to drain from the system. When the appropriate amount of water is drained, the first valve remains at least partially open and second valve is shut by the controller. The water drained from the system is replenished by addition of make-up water from a source of water used by the system and the system returns to normal operation. In one embodiment, the details regarding the procedure are recorded by a component of the system, such as the control unit and/or the legal storage unit. Relevant details include, but are not limited to, the amount of water drained from the system, the amount of water added to the system, the duration of the blow down, the start and stop times of the blow down procedure, the value of the conductivity parameter before, during and/or after the procedure and the like.

### Biocide Monitoring and Control

If the parameter is biocide levels, such as, but not limited to, halogen levels, a test point will determine the biocide parameter. The results (the value of the parameter) are recorded by a component of the system, such as the controller and/or the legal storage unit.

If the value of the biocide parameter determined by the test point triggers a treatment action (for example, the value is either too high or too low), the controller will direct the system to take an action. The action taken may depend on factors known in the art, such as the composition of the water/make-up water utilized by the system, the type of biocide treatment agent used and the operating parameters of the system. Therefore, the specific actions taken regarding the biocide parameter may vary depending on the forgoing. If the value of the biocide parameter is too high, the controller may take no action at all or initiate a blow down as described above. The controller may also send an alert to notify a user or a defined group. The alert function is discussed herein and any form of such an alert, or any combination thereof, may be utilized. The blow down occurs as described above utilizing conduit 50. However, in this operation the termination of the blow down may be determined by the value of the biocide parameter in addition to the other factors discussed above. In one embodiment, the termination of the blow down is determined by the value of the biocide parameter and once the value of the biocide parameter is within the acceptable range, the blow down is terminated. In one embodiment, the details regarding the procedure are recorded by a component of the system, such as the control unit and/or the legal storage unit. Relevant details include, but are not limited to, the amount of water drained from the system, the amount of water added to the system, the duration of the blow down, the start and stop times of the blow down procedure, the value of the halogen parameter before, during and/or after the procedure and the like.

If the value of the biocide parameter is too low, the controller initiates the addition of a biocide treatment agent (for example, halogen or a free halogen donor) to the water stream to compensate for the low biocide levels. The controller may also send an alert to notify a user or a defined group. The alert function is discussed herein and any form of such an alert, or any combination thereof, may be utilized. The system may add the biocide treatment agent to the water stream via any method known in the art. In one embodiment, the system adds the biocide treatment agent to the water stream through a triggered injection mode. In another embodiment, the system adds the biocide treatment agent to the water stream through a slug injection mode. The slug injection mode by be used for routine addition of biocide regardless of the readings of the test point measuring for the biocide parameter (such as routine addition of halogen treatment agent to maintain halogen levels in the acceptable range). The triggered injection mode may be used when the system determines biocide addition is required based on a value of the biocide parameter. The slug injection mode and the continuous injection mode may be used together if desired.

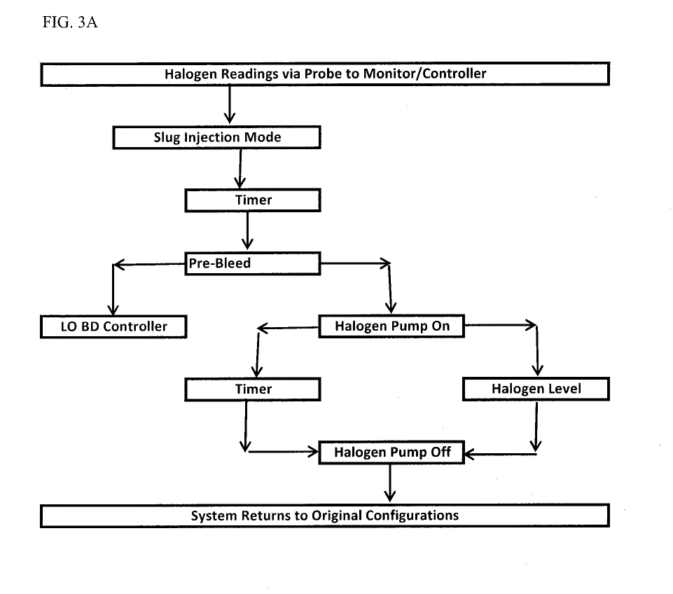

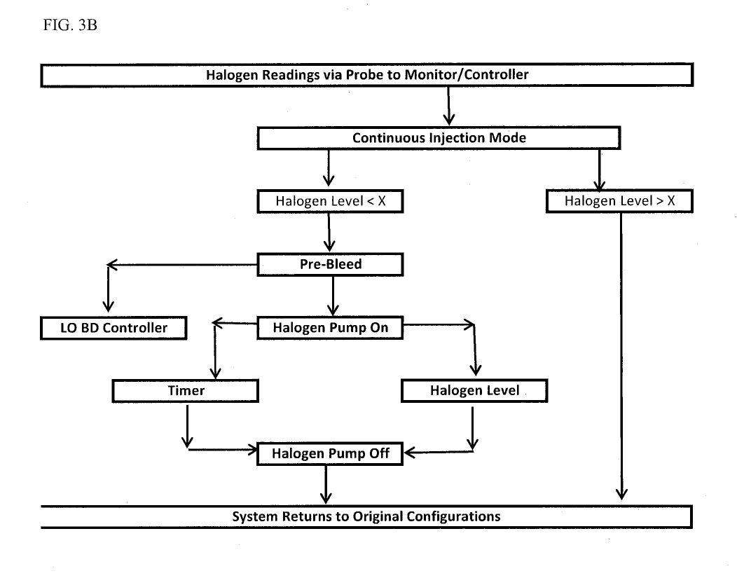

The operation of the slug injection mode is shown in FIG. 3A. In the slug injection mode, the addition of biocide treatment agent is determined according to a pre-defined schedule. The per-defined schedule may be set by a user or a defined group. The pre-defined schedule may be input into the control unit or may be input into the treatment point. In one embodiment, the pre-defined schedule can be changed only by a defined group of individuals. Further, in one embodiment, any change in the pre-defined schedule or any attempt to change the pre-defined schedule is recorded by a component of the system, such as the controller of the legal storage unit. In one embodiment, the pre-defined schedule is independently selected from every 12 hours, every 24 hours, every 2 days, every 3 days, every 4 days, every 5 days, every 6 days or every week; other time points may also be used.

In the slug injection mode, the controller initiates the addition of the biocide treatment agent (such as halogen or a free halogen donor) as dictated by the pre-defined schedule (indicated as timer in FIG. 3A). The system will initiate a pre-bleed of the system such as through activation of a drain conduit, such as drain conduit 50. Operation of the drain conduit 50 is described above. The pre-bleed will last for a pre-set duration. The pre-set duration may be input into the controller or the treatment point. The controller will lock out any action, routine or otherwise, of the drainage conduit 50. The conductivity test point may continue to operate and record values, however, despite the determined parameter no action will be taken based on the determined parameter to initiate a blow down or drainage of the system.

After termination of the pre-bleed step as discussed above, the controller activates the treatment point containing the biocide treatment agent. In one embodiment, the biocide treatment agent is halogen or a free halogen donor, although other compounds may be used. The injection element associated with the biocide treatment point is activated (such as by the controller and the treatment point injects the halogen treatment agent into the water stream. The valves associated with the treatment point are, in one embodiment, normally open. In the case where such valves are closed, the controller may open such valve prior to activation of the injection element. The amount of biocide treatment agent added to the water stream may be determined by monitoring the biocide parameter and continuing injection of the biocide treatment agent until the biocide parameter is within the acceptable range or may be determined by injecting the biocide treatment agent for a pre-determined amount of time. If the addition of the biocide treatment agent is governed by a pre-determined amount of time, the pre-determined amount of time may be input into the control unit or may be input into the treatment point. In one embodiment, the pre-determined amount of time can be changed only by a defined group of individuals. Further, in one embodiment, any change in the pre-determined amount of time or any attempt to change the pre-determined amount of time is recorded by a component of the system, such as the controller of the legal storage unit. Once the predetermined amount of time has expired or the biocide parameter is within the acceptable range, the controller terminates addition of the treatment agent (for example, by shutting down the halogen pump). In one embodiment, the details regarding the procedure are recorded by a component of the system, such as the control unit and/or the legal storage unit. Relevant details include, but are not limited to, the length of time of biocide treatment agent injection, the start time and the stop time of such injection, the amount and/or volume of biocide treatment agent injected, the biocide parameter as determined before, during and/or after the biocide treatment agent injection and details regarding the blow down procedure as discussed above. The volume injected may be determined by the validating means associated with the treatment point as discussed above or by the injection element settings combined with the duration of the injection.

The triggered injection mode is shown in FIG. 3B. In the continuous injection mode, controller receives the biocide parameter from the biocide test point. If the biocide parameter triggers a treatment action, the controller initiates the addition of the biocide treatment agent. The addition of the biocide treatment agent occurs as described above for the slug injection mode.

With either mode of biocide treatment agent injection, once the biocide injection element has been de-activated by the controller, all systems will return to their routine configuration.

### Biofilm Monitoring and Control

If the parameter is biofilm levels, or an agent indicative of the presence of biofilm, a biofilm test point will determine the biofilm parameter. The above parameters are generally referred to as a biofilm parameter. The results (the value of the parameter) are recorded by a component of the system, such as the controller and/or the legal storage unit.

If the biofilm parameter determined by the test point triggers a treatment action the controller will direct the system to take an action. The action taken may depend on factors known in the art, such as, but not limited to, the value of the parameter, the biofilm treatment agent to be used, the operating parameters of the system and the like. Therefore, the specific actions taken regarding the biofilm parameter may vary.

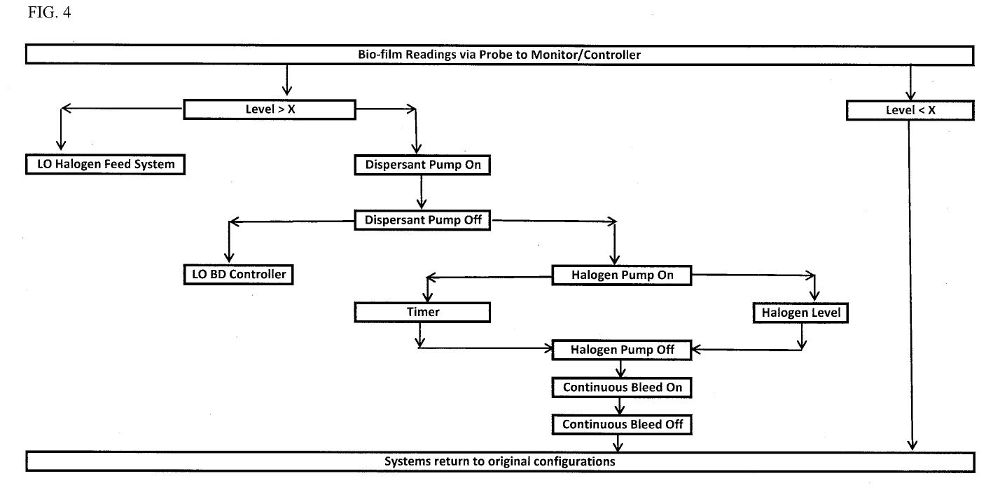

The operation of the system when the value of the biofilm parameter is too high is shown in FIG. 4. If the value of the biofilm parameter is below the acceptable range, the system continues normal operation. If the value of the biofilm parameter triggers a treatment action, the controller initiates the addition of a biofilm treatment agent (for example, a biodispersant) to the water stream to compensate for the high biofilm levels. The controller may also send an alert to notify a user or a defined group. The alert function is discussed herein and any form of such an alert, or any combination thereof, may be utilized.

On determining the value of the biofilm parameter triggers a treatment action, the system, such as through the controller locks out any action, routine or otherwise, regarding the addition of the biocide treatment agent. The biocide test point may continue to monitor the biocide parameter, but the system will not take any action based on the determined biocide parameter. Once the biocide treatment point is locked out as discussed above, the system, such as through the controller activates the biofilm treatment point to inject the biofilm treatment agent into the water stream. The system activates the injection element and opens the valve associated with the biofilm treatment point. Optionally, the valve associated with the biofilm treatment point may remain open requiring only the activation of the injection element. The amount of biofilm treatment agent added to the water stream may be determined by monitoring the biofilm parameter and continuing injection of the biofilm treatment agent until the biofilm parameter is within the acceptable range or may be determined by injecting the biofilm treatment agent for a pre-determined amount of time. If the addition of the biofilm treatment agent is governed by a pre-determined amount of time, the pre-determined amount of time may be input into the control unit or may be input into the treatment point. In one embodiment, the pre-determined amount of time can be changed only by a defined group of individuals. Further, in one embodiment, any change in the pre-determined amount of time or any attempt to change the pre-determined amount of time is recorded by a component of the system, such as the controller of the legal storage unit. Once the predetermined amount of time has expired or the biofilm parameter is within the acceptable range, the system shuts terminates addition of the biocide treatment agent. In one embodiment, the details regarding the procedure are recorded by a component of the system, such as the control unit and/or the legal storage unit. Relevant details include, but are not limited to, the length of time of biofilm treatment agent injection, the start time and the stop time of such injection, the amount and/or volume of biofilm treatment agent injected, the biofilm parameter as determined before, during and/or after the biofilm treatment agent injection and the like. The volume injected may be determined by the validating means as discussed above or by the injection element settings combined with the duration of the injection.

Once the injection element associated with the biofilm treatment point is shut off, the controller then locks out any action associated with the conductivity parameter and any routine blow down operations. The conductivity test point may continue to monitor the conductivity parameter, but no actions will be taken based on the determined conductivity parameter. Subsequently the addition of a biocide treatment agent is initiated. Such operations are described above. The details regarding the procedure are recorded by a component of the system, such as the control unit and/or the legal storage unit. Relevant details include, but are not limited to, the length of time of biocide treatment agent injection, the start time and the stop time of such injection, the amount and/or volume of biocide treatment agent injected, the biocide parameter as determined before, during and/or after the biocide treatment agent injection and the like.

Once the biocide addition is complete, the controller initiates a continuous bleed by activating the drain conduit 50. Such a drainage of the system aids in removing biofilm from the system that has been dislodged by the previously described procedures. Operation of the drain conduit 50 is as described above. The bleed will last for a pre-set duration. The pre-set duration may be input into the controller. Once the pre-set duration has expired, the system returns to the original configurations and continues operation as normal. In one embodiment, the details regarding the procedure are recorded by a component of the system, such as the control unit and/or the legal storage unit. Relevant details include, but are not limited to, the amount of water drained from the system, the amount of water added to the system, the duration of the blow down, the start and stop times of the blow down procedure, the value of the conductivity parameter before, during and/or after the procedure and the like.

### Routine Cleaning and Disinfection

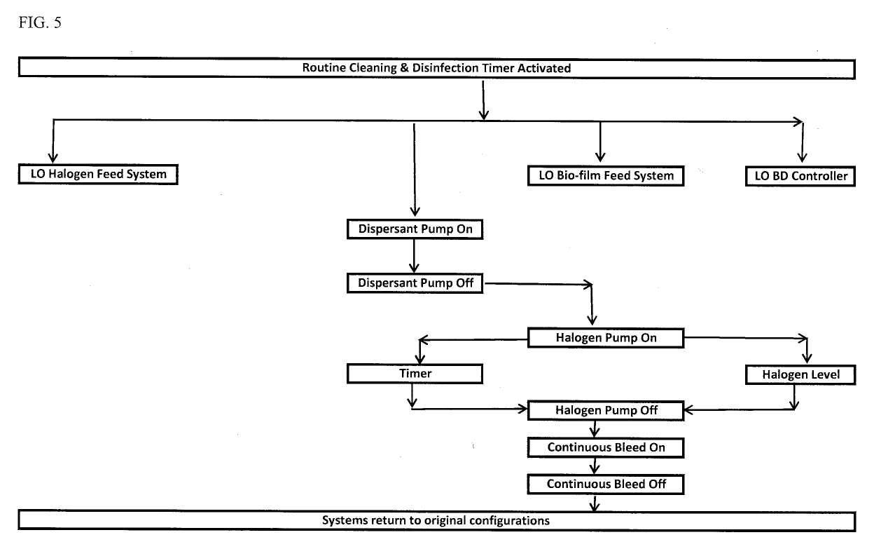

In addition to the foregoing, the system, such as through the controller, may be set for routine cleaning and maintenance operations. In such an operation, the system deploys both a biofilm treatment agent and a biocide treatment agent to maintain the system in a desired state. In this operation, the system, such as through the controller, locks out operations associated with the biocide parameter, the conductivity parameter and biofilm parameter. The test points may continue to determine the biocide parameter, the biofilm parameter and the conductivity parameter, however, no action will be taken by the system based on the determined parameters. The details of the operation are shown in FIG. 5.

Subsequently, the system, such as through the controller, activates the biofilm treatment point to inject the biofilm treatment agent into the water stream. The addition of the biofilm treatment agent is described above. In one embodiment, the details regarding the procedure are recorded by a component of the system, such as the control unit and/or the legal storage unit. Relevant details include, but are not limited to, the length of time of biofilm treatment agent injection, the start time and the stop time of such injection, the amount and/or volume of biofilm treatment agent injected, the biofilm parameter as determined before, during and/or after the biofilm treatment agent injection and the like. The volume injected may be determined by the validating means as discussed above or by the injection element settings combined with the duration of the injection.

Once the injection element associated with the biofilm treatment point is shut off, the system, such as through the controller, activates the biocide treatment point to inject the biocide treatment agent into the water stream. The addition of the biocide treatment agent is described above. In one embodiment, the details regarding the procedure are recorded by a component of the system, such as the control unit and/or the legal storage unit. Relevant details include, but are not limited to, the length of time of biocide treatment agent injection, the start time and the stop time of such injection, the amount and/or volume of biocide treatment agent injected, the biocide parameter as determined before, during and/or after the biocide treatment agent injection and the like.

Once the injection element associated with the biocide treatment point is shut off, the system, such as through the controller initiates a continuous bleed by activating the drain conduit 50. Such a drainage of the system aids in removing biofilm from the system that has been dislodged by the previously described procedures. Operation of the drain conduit 50 is as described above. The bleed will last for a pre-set duration. The pre-set duration may be input into the controller. Once the pre-set duration has expired, the system returns to the original configurations and continues operation as normal. In one embodiment, the details regarding the procedure are recorded by a component of the system, such as the control unit and/or the legal storage unit. Relevant details include, but are not limited to, the amount of water drained from the system, the amount of water added to the system, the duration of the blow down, the start and stop times of the blow down procedure, the value of the conductivity parameter before, during and/or after the procedure and the like.

What is claimed:

1. A system for water treatment, the system comprising:
a. at least one test point in communication with a water stream for determining a parameter of the water stream, each test point comprising a sensor capable of measuring the parameter;
b. at least one treatment point in communication with the water stream to release a treatment agent into the water stream;
c. a control unit, wherein the control unit receives information regarding the parameter and directs the release of an amount of the treatment point from the treatment point into the water stream if the parameter is within a defined treatment range; and
d. a legal storage unit;
wherein the control unit and the legal storage unit each records at least one parameter related to the water stream.

2. The system of claim 1, wherein the parameter is the presence of a monitored agent, the amount of the compound released into the water stream, the presence of a biofilm, the presence of a living organism, the conductivity of the water stream, the temperature of the water stream, the pH of the water stream or a combination of the foregoing.

3. The system of claim 2, wherein the living organism is a bacteria, a fungus, a virus or a combination of the foregoing.

4. The system of claim 2, wherein the living organism is a Legionella species or a Mycobacterium species.

5. The system of claim 2, wherein the living organism is Legionella pneumophila or Mycobacterium avium.

6. The system of claim 1, wherein a first defined group has access to the parameter recorded on the control unit and a second defined group has access to the parameter recorded on the legal storage unit.

7. The system of claim 1, wherein the legal storage unit is maintained in a location removed from the system.

8. The system of claim 1, wherein the parameter recorded on the legal storage unit cannot be altered.

9. The system of claim 1, wherein the legal storage unit has an anti-tampering device to detect an attempt to change a parameter recorded on the legal storage unit.

10. The system of claim 1, wherein the legal storage unit provides legally sufficient evidence of the recorded parameter.

11. The system of claim 1, wherein the system comprises more than one test point and a single treatment point.

12. The system of claim 1, wherein the system comprises more than one test point and more than one treatment point.

13. The system of claim 1, wherein the system comprises three test points and two treatment points.

14. The system of claim 1, wherein the system comprises a first test point to measure the level of a first parameter, a second agent test point to measure the level of a second parameter, a third test point to measure the level of a third parameter, a first treatment point to release a first treatment agent and a second treatment point to release a second treatment agent.

15. The system of claim 14, wherein the first parameter is free halogen, the second parameter is biofilm, an agent indicative of the presence of biofilm, bacteria or an agent indicative of the presence of a bacteria and the third parameter is conductivity of the water stream.

16. The system of claim 14, wherein the first treatment agent is free halogen or a free halogen donor and the second treatment agent is a biodispersant.

17. The system of claim 15, wherein the agent indicative of the presence of the biofilm is adenosine tri-phosphate.

18. The system of claim 1, wherein each treatment point comprises a valve, a pump and optionally a device to measure the flow of the treatment agent and is in communication with a supply of at least one treatment agent.

19. The system of claim 19, wherein the supply of the treatment agent is a reservoir containing the treatment agent.

20. The system of claim 1, wherein each test point comprises a valve and is in communication with a drain port.

21. The system of claim 1, wherein the control unit sends an alert to at least one user on a predetermined schedule.

22. The system of claim 1, wherein the control unit sends an alert to at least one user when the parameter is within a defined range, when the treatment agent is released into the water stream, when the level of the treatment agent is low, when an operating parameter of the system is modified or a combination of the foregoing.

23. The system of claim 1, wherein the system further comprises at least one blow down drain line.

24. The system of claim 23, wherein each blow down drain line comprises a manual throttling valve, a solenoid valve and a filter positioned in between the two.

25. The system of claim 1, wherein the least one test point and at least one treatment point are contained in a by-pass loop in communication with the water system.

26. The system of claim 1, wherein the controller is in communication with each test point, each treatment point or a combination of the foregoing and the legal storage unit is in communication with the controller, each test point, each treatment point or a combination of the foregoing.

27. The system of claim 1, wherein the controller and the legal storage unit records the operating parameters of the system.

28. The system of claim 1, wherein an operating parameter of the system can be changed only by a defined group.

29. The system of claim 1, wherein the test point determines the parameter according to a defined schedule.

30. The system of claim 1, wherein the defined schedule is independently selected from every 5 second, every 30 seconds, every 45 seconds, every minute, every 5 minutes, every 30 minutes, every hour, every 5 hours, every 12 hours or every 24 hours.
